(19) United States
(12) Patent Application Publication
(10) Pub. No.: US 2002/0119804 A1
(43) Pub. Date: Aug. 29, 2002

(54) Method and apparatus for supplying email information remotely via a mobile device

(76) Inventors: John Isaac Chandan Gomes, Singapore (SG); Ngee Chuan Tan, Singapore (SG)

Correspondence Address: HEWLETT-PACKARD COMPANY, Intellectual Property Administration, P.O. Box 272400, Fort Collins, CO, 80527-2400, US

(21) Appl. No.: 09/923,268

(22) Filed: Aug. 2, 2001

(30) Foreign Application Priority Data
Feb. 28, 2001 (SG) 100101253-3

(51) Int. Cl. H04M 1/00

(52) U.S. Cl. 455/557; 455/420

(57) ABSTRACT

A method and apparatus for applying information stored remotely to an appliance via a mobile device are provided. The mobile device initiates the process by transmitting instructions to a computer system via a communication network. The instructions designate the information to be processed as well as the appliance to which the information is to be applied. According to the instructions, the computer system retrieves the information and converts the information to a document suitable for the appliance. The computer system then applies the document to the designated appliance.

### BACKGROUND OF THE INVENTION

This invention relates to a method and an apparatus for applying remotely stored information, especially emails, via a mobile device.

Conventionally, after receiving an email with or without attachment a user can apply the received information to an appliance. For example, the user can generate a hard copy of it by transmitting the received information from the computer to an appliance, such as a printer connected to the computer directly or via a network, or as a fax machine. When the user is traveling, however, he needs a portable media like a laptop for retrieving emails and for accessing and processing them. If he wants a printed version of the email and/or the attachment, he has to connect the laptop to an appropriate appliance, and quite often, to install the appliance. These may not be desirable, especially for a user who travels often.

With the advent of mobile revolution, mobile devices such as mobile phones and personal digital assistants provide a solution to access information or data remotely. Some devices even allow the user to store some information in them. Nevertheless, the user of the mobile devices cannot apply the information to an appliance conveniently in that he still needs to physically connect the devices with an appliance. Furthermore, due to the compactness and the limitation of size, most mobile devices are short of storage space and processing power. Inevitably, this shortage limits the capacity of information or data that a user can store or retrieve. Besides, some mobile devices like mobile phones do not even allow applications like WinWord™ to be run on them. Therefore, users of these mobile devices are restrained from accessing documents created by these applications.

### SUMMARY OF THE INVENTION

In an embodiment of the invention, the invention provides a convenient method and apparatus to allow a user of a mobile device to apply remotely stored information, especially emails, to an appliance.

In an embodiment according to one aspect of the invention, in a method for applying information to an appliance via a mobile device, the mobile device initiates the process by transmitting an information request to a computer system via a first communication network. The computer system generates a list of all available information. The list of all available information is then transmitted from the computer system via the first communication network to the mobile device. The mobile device designates from the list of available information a designated information to be processed and the appliance to which the designated information is to be applied as instructions. The instructions are transmitted from the mobile device to the computer system via the first communication network. The computer system retrieves the designated information and applies the designated information to the designated appliance via a second communication network for processing.

According to another aspect of the invention, a computer system has a first interface for receiving both information requests and instructions from the mobile device via a first communication network. The information requests initiate generating a list of all available information. The instructions designate from all available information a designated information to be processed and the appliance to which the designated information is to be applied. The appliance is connected to the computer system at a second interface via a second communication network. The computer system has a server computer system for processing and answering the information requests, for processing the instructions and for applying the designated information to the appliance for processing.

The invention provides the advantage that a user may retrieve his emails received by an email server by using his mobile device without the need of an unwieldy laptop. He may check the subjects of the emails at the display of his mobile device and apply designated emails to an appropriate appliance, for instance, in his neighborhood. Therefore, the user needs neither to directly connect an unwieldy laptop to the appropriate appliance by a physical connection nor to install the appliance by an appropriate driver for the appliance. Furthermore, the invention provides the possibility to print attached documents generated by applications with a huge need of computing resources from the mobile device, which itself does not provide sufficient calculating resources.

### BRIEF DESCRIPTION OF THE DRAWINGS

FIG. 1 illustrates a first embodiment of the invention; and

FIG. 2 illustrates a second embodiment of the invention.

### DETAILED DESCRIPTION OF THE INVENTION

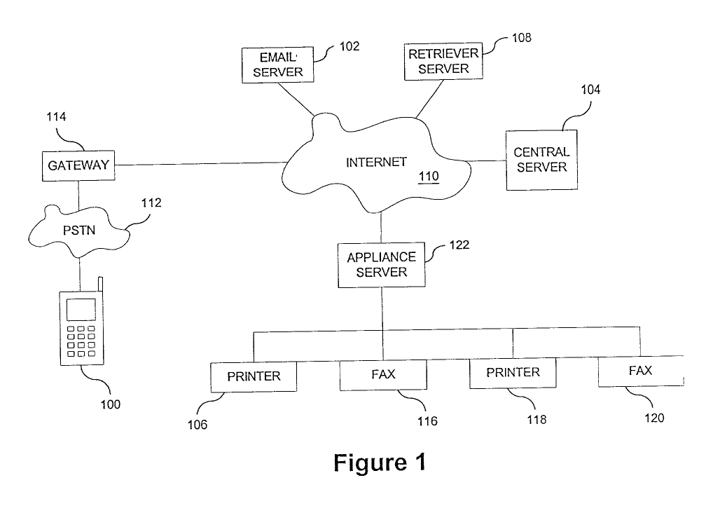

In a first embodiment of the invention as shown in FIG. 1, a user of a mobile device 100 such as a mobile phone can print emails with or without attachments stored in an email server 102 via both a central server 104 and a printer 106. If not specially pointed out in the following, the term “email” means likewise emails with or without attachments. Attachments can be, for instance, documents generated by usual computer programs like WinWord. To enable the user to access the emails remotely from his standard email receiving computer (not shown), the emails have to be downloaded from the email server 102 to a retriever server 108 via the internet 110.

When the user is away from his standard email receiving computer and wants a printed copy of his emails, the user may use his mobile phone 100 to request the email server 102 for information about received emails. The request reaches the central server 104 via a Public Switched Telephone Network (PSTN) 112, a gateway 114 and the internet 110. For communication between the mobile device 100 and the gateway 114, standard telecommunication protocols such as Wireless Application Protocols (WAP) are used. It is understood that WAP is used as a transport layer protocol based on the transport layer GSM. Higher data rate transport layers such as 3G or as Telco can also be used. In the context of WAP, the mobile phone is WAP-enabled, and the request from the mobile device 100 is in the following illustrative format:

WAP Header

Email Server

Email Protocol

Username

User Password

WAP Trailer.

The parameter “Email Server” designates the email server 102, where the user “owns” an email account, and the parameter “Email Protocol” specifies the format, which has to be used when communicating with the email server 102. The parameters “Username” and “User Password” designate and allow communication with the email account of the user for retrieving received emails from the email server 102. The gateway 114 converts the request to an HTTP format suitable for transfer through the internet 110.

The request of the gateway 114 is packed into an HTTP packet in an illustrative format shown below:

HTTP header

/MapleWMUCMServer/AddEmail.asp

Email Server

Email Protocol

Username (for identifying at the email server 102)

User Password (for the purpose of security)

HTTP Trailer.

Such an HTTP packet then will be transmitted to the central server 106 via the internet 108. In this embodiment, upon receiving it, the central server 106 is activated by the parameter “/MapleWML/CMServer/AddEmail.asp” to run a script. Thus the information following this parameter, i.e., the parameters “Email Server,” “Email Protocol,” “Username,” and “User password,” is needed at the central server 106 to run and execute the script.

It is noted that the mobile device 100 needs to install settings for identifying the gateway 114 and the central server 104 in advance. The mobile device 100 will then be able to contact the appropriate central server 104 via the appropriate gateway 114. Such a technology is well known in the field of wireless communication.

After receiving the request, the central server 104 instructs the retriever server 108 via the internet 110 to download the received emails of the user from the specified email server 102 in the specified email protocol format and to generate a list of available emails. Such an email protocol format can be, for instance, IMAP4 or POP3. Alternative email protocol formats can also be used. The retriever server 108 then transmits a retrieving request comprising the parameters “Username” and “User Password” to the email server 102 via the internet 110.

After receiving the retrieving request, the email server 102 packs the received emails and transmits them to the retrieving server 108 via the internet 110 as a response to the retrieving request. The response comprises the following parameters:

Numbers of Emails

Size of each Email

Size of Attachments of each Email

Email Content,

where the parameters “Number of Emails,” “Size of each Email” and “Size of Attachments of each Email” enable the retriever server 108 to split the “Email Content” in individual received emails with or without attachments and to store all available emails in an email database (not shown). The retriever server 108 now generates a list of available emails for the particular user, that is, a list of all emails, which are downloaded to the retriever server 108 and stored in the email database for the particular user.

After generating the list of available emails, the retriever server 108 packs a reply in the following illustrative HTTP format:

HTTP Header

List of Emails

HTTP Trailer,

where the parameter “List of Emails” includes the list of available emails for the particular user at the retriever server 108. The retriever server 108 further transmits its reply through the established connections via both the internet 110 and the central server 104 towards the gateway 114, which in turn would convert the reply into a WAP format for displaying on the mobile device 100.

The user selects an email to be printed from the list of available emails and a printer 106 to which the email is to be printed via the mobile device 100. Such selections are incorporated into instructions, printing instructions in the case of this embodiment, by the mobile device 100 according to the following illustrative format:

WAP Header

Username

User Password

Designated Email

Appliance ID

WAP Trailer.

The parameter “Designated Email” identifies the email to be printed, while the parameter “Appliance ID” identifies the appliance to which the email is to be applied. In the case of printing an email, the “Appliance ID” will be the printer name of a selected printer 106.

The mobile device 100 then transmits the printing instructions to the central server 104 via the PSTN 112, the gateway 114, and the internet 110. After receiving such instructions, the central server 104 stores the parameter “Appliance ID” in an appliance database (not shown). The central server 104 requests for the email designated by the parameter “Designated Email” to be uploaded from the retriever server 108 by transmitting to the retriever server 108 the contents of the parameter “Designated Email”. The central server 104 identifies and requests the retriever server 108 according to the parameters of “Username” and “User Password.”

The retriever server 108 accordingly packs the email identified by the parameter “Designated Email” into an HTTP packet, for example:

HTTP Header

/MapleWML/CMServer/EmailUpload.asp

Username

User Password

Designated Email

Size of the Email

Size of Attachments of the Email

Job ID

Email Content

HTTP Trailer,

wherein the parameter “Job_ID” identifies the source of the job, especially, where the email to be printed comes from. The parameter “/MapleWML/CMServer/ EmailUpload.asp” will initiate the central server 104 to retrieve the information contained therein, including the designated email which is contained in “Email Content.”

Further, the email server 102 needs to be publicly accessible, that is, in a public domain so that by using its Username and User Password, other computers or servers can access and retrieve emails from it.

Additionally, a plurality of appliances, including, for example, the printer 106, a fax machine 116, a further printer 118, and a further fax machine 120, are connected to an appliance server 122 and are registered in the central server 104. The appliance server 122 tells the central server 104 which appliances are logged in and tells the central server 104 the Appliance Identities (IDs) of the individual appliances and appliance server Internet Protocol (IP) address. The appliances get registered by the appliance server 122 which is transmitting to the central server 104 via the internet 110, for example, an HTTP packet in the following illustrative format:

HTTP header

/MapleWML/CMServer/ApplianceLogin.asp

Appliance ID

Password for the Appliance Server

Appliance Server IP Address

HTTP Trailer,

where the parameter “/MapleWML/CMServer/ApplianceLogin.asp” activates the central server 104 to run a script such that the information following this parameter in the packet will be loaded into the appliance database of the central server 104. The parameter “Appliance ID,” for example, the appliance name, identifies the appliance to be registered. The parameter “Appliance Server IP Address” helps the central server 104 to locate the appliance server 122, and further to know where the appliances are.

The central server 104 transmits the designated email as well as the parameter “Appliance ID” as stored in the appliance database and designated in the printing instructions, e.g., by the printer name, to the appliance server 122 via the internet 108. The central server 104 is able to locate the appliance server 122 through the parameter “Appliance Server IP Address.” The appliances such as the printer 106, the fax machine 116, the further printer 118, and the further fax machine 120, are connected to the appliance server 122 as already mentioned above. The appliance server 122 is installed with all the necessary applications and drivers of those connected appliances, in particular, printer drivers of the connected printers 106 and 118.

The appliance server 122 converts the email as well as, if existing, attached documents to a format suitable for the designated appliance. In the present embodiment, the document is converted to a print job in a Page Descriptive Language (PDL) format. According to the printing instruction, the print job is passed to the designated printer 106 identified by the parameter “Appliance ID,” e.g., the printer name. A hard copy of the email and of possibly attached documents will be then generated.

After applying the email to the designated appliance and after completely processing the email by the designated appliance, the appliance server 122 transmits a message with the value “finished” or otherwise “fault” to the central server 104. The central server 104 converts the message and transmits it via the internet 110 to the mobile device 100 via a short message service (SMS). Such a message in a SMS packet may have the following illustrative format:

SMS header

Designated Email

Appliance ID

Status

SMS Trailer,

where the parameters “Designated Email” and “Appliance ID” tell the user, which email he has transmitted to which appliance. Finally, the parameter “Status” tells the user, whether applying his email is finished or broken off due to a fault.

Alternatively, the user can apply the email to other appliances such as the fax machines 116 and 120. The user needs to designate the appliance in the instructions being transmitted to the central server 104 by incorporating the appropriate appliance identity into the instructions. Accordingly, the appliance server 122 converts the retrieved email and possibly attached documents to a format suitable for the designated appliance and further passes it to the appliance.

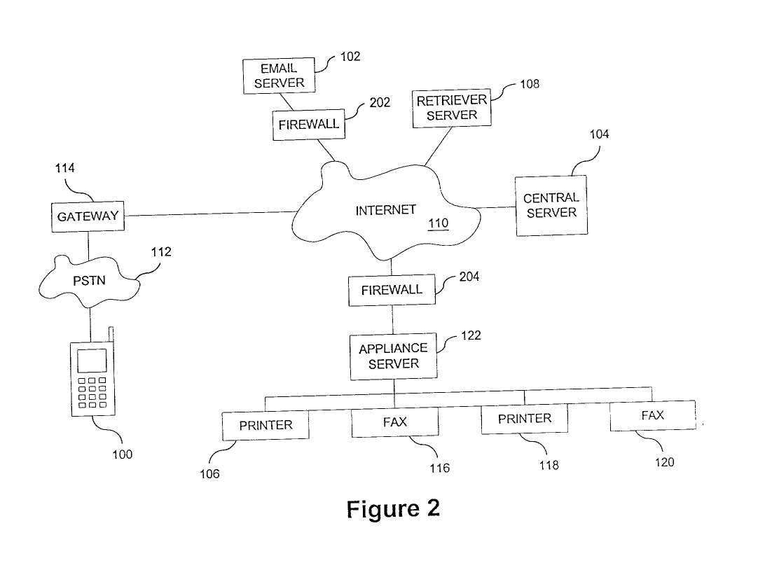

A second embodiment of the invention is shown in FIG. 2. The difference between the second embodiment and the first embodiment of the invention is the existence of a first firewall 202 protecting the email server 102 and of a second firewall 204 protecting the appliance server 122. The protection is mainly designated against attacks, e.g., unauthorized inquiries, from the internet 110.

Then, the retriever server 108 is not able to start a communication with the email server 102. The email server 102 instead periodically polls the retriever server 108. Given at least one request of the retriever server 108 for the corresponding email server 102, the retriever server 108 is allowed to communicate with the email server 102 due to the polling action of the email server 102.

Similarly, the central server 104 is not able to start a communication with the appliance server 122. The appliance server 122 instead periodically polls the central server 104. Given at least one email to be applied from the central server 104 to the appliance server 122, the central server 104 is allowed to communicate with the appliance server 122 due to the polling action of the appliance server 122.

Alternatively, the email server 102 as well as the retriever server 108 are together protected by the first firewall 202. Then, the central server 104 is not able to start a communication, neither with the email server 102 nor with the retriever server 108. The retriever server 108 instead retrieves all available emails from the email server 102 and generates the list of available emails. Further, the retriever server 108 periodically polls the central server 104. Given at least one request of the central server 104 for the corresponding email server 102, the retriever server 108 transmits the list of available emails to the central server 104 due to the polling action of the retriever server 108.

As a further alternative, the central server 104 and the retriever server 108 are incorporated together in one common server (not shown). Then, the common server downloads the received emails from the email server 102 and generates the list of available emails without the need of a separate retriever server 108.

Other alternatives can be made to the above described embodiments. For example, the emails can be forwarded to and stored in the central server 104 in advance so that the central server 104 will retrieve the emails directly from its storage unit (not shown). The appliances can also be connected to the central server 104 directly, in which case the central server 104 also acts as appliance server 122.

Additionally, other mobile devices 100 such as personal digital assistants can be used on condition that they are able to communicate with the gateway 114.

In the following, some alternative embodiments of the invention will be described.

In one embodiment, the information is stored in a first sub-computer system. Then, the first part of the response to the information request comprises four steps. In the first step a second sub-computer system is instructed via a third communication network to download all available information from the first sub-computer system to the second sub-computer system. The second step comprises downloading all available information from the first sub-computer system to the second sub-computer system via a fourth communication network. As third step, the list of all available information is generated by the second sub-computer system. In the fourth step finally the list of all available information is transmitted from the second sub-computer system via the third communication network to the computer system.

The computer system may convert the designated information to a formatted information suitable for the appliance according to the instructions. Then, the formatted information is transmitted from the computer system to the appliance via the second communication network. Finally, the formatted information is applied to the appliance for processing.

In one embodiment, at least two of the group comprising the first communication network, the second communication network, the third communication network, and the fourth communication network, can share a part of one common communication network, for instance the internet.

A plurality of appliances may be registered in the computer system. The plurality of appliances can be connected to the computer system via the second communication network. The mobile device designates a first appliance from the plurality of appliances by specifying it in the instructions.

In this preferred embodiment, the plurality of appliances is connected to an appliance server, which is a remote part of the computer system. The appliance server is provided for converting the designated information to the formatted information suitable for the appliance.

Furthermore, the first communication network includes a gateway with which the mobile device communicates by using standard telecommunication protocols. The gateway converts the instructions to a format which the computer system understands. Preferably, the instructions are converted to a format suitable for transfer through the internet.

The first appliance can be a printer or a fax machine. In one embodiment, the first appliance is a printer and the computer system converts the information to a print job in a format suitable for printing, for instance a PDL format.

The second sub-computer system may be able to download all available information from the first sub-computer system only if the first sub-computer system polls the second sub-computer system. This may be due to a first firewall protecting the first sub-computer system against attacks, e.g., unauthorized inquiries. Similarly, the computer system may be able to transmit the formatted information to the appliance only if the appliance polls the computer system, because the appliance is protected by a second firewall against attacks, e.g., unauthorized inquiries.

In one embodiment, the computer system transmits a message to the mobile device after applying the formatted information to the appliance. Preferably, such a message is an information about completion of applying the formatted information to the appliance. The message may be transmitted to the mobile device via a short message service (SMS).

Given the information being stored in a first sub-computer system, which is connected to the computer system, and the information requests designating the first sub-computer system, the computer system further comprises a third interface connected to the server computer system for receiving the information sent from the first sub-computer system via a third communication network.

The computer system may further comprise a fourth interface connected to the server computer system for sending the information received from the first sub-computer system to a second sub-computer system via a fourth communication network.

Given the first communication network, the second communication network, the third communication network, and/or the fourth communication network being a part of one common communication network, the first interface, the second interface, the third interface, and/or the fourth interface are realized by one common interface.

The server computer system may convert the designated information to a format suitable for the appliance.

In this embodiment, the appliance is a printer and the server computer system converts the designated information to a print job in a format suitable for printing on the printer.

What is claimed is:

1. A method for applying information to an appliance via both a mobile device and a computer system, the method comprising:
transmitting an information request from the mobile device to the computer system via a first communication network;
generating a list of all available information as a first part of a response to the information request;
transmitting the list of all available information from the computer system via the first communication network to the mobile device as a second part of the response to the information request;
designating from the list of all available information a designated information to be processed and the appliance to which the designated information is to be applied as instructions in the mobile device;
transmitting the instructions from the mobile device to the computer system via the first communication network; and
retrieving the designated information and applying the designated information to the appliance via a second communication network for processing according to the instructions.

2. The method of claim 1, wherein the information is stored in a first sub-computer system, and wherein the first part of the response to the information request comprises:
instructing via a third communication network a second sub-computer system to download all available information from the first sub-computer system to the second sub-computer system;
downloading all available information from the first sub-computer system to the second sub-computer system via a fourth communication network;
generating the list of all available information by the second sub-computer system; and
transmitting the list of all available information from the second sub-computer system via the third communication network to the computer system.

3. The method of claim 1, wherein the method further comprises:
converting the designated information to a formatted information suitable for the appliance by the computer system according to the instructions;
transmitting the formatted information from the computer system to the appliance via the second communication network according to the instructions; and
applying the formatted information to the appliance for processing according to the instructions.

4. The method of claim 1, wherein a plurality of appliances is connected to the computer system, the mobile device further designating the appliance among said plurality of appliances in the instructions.

5. The method of claim 4, wherein said plurality of appliances is registered in the computer system.

6. The method of claim 4, wherein the mobile device designates the appliance by specifying the appliance identity in the instructions.

7. The method of claim 4, wherein the plurality of appliances is connected to an appliance server as a remote part of the computer system, and wherein the appliance server converts the designated information to a formatted information suitable for the appliance.

8. The method of claim 1, wherein the first communication network includes a gateway with which the mobile device communicates by using standard telecommunication protocols, and the gateway converts the instructions to a format which the computer system understands.

9. The method of claim 1, wherein the appliance is a printer, and the computer system converts the designated information to a print job in a format suitable for printing.

10. The method of claim 9, wherein the computer system converts the designated information to a PDL format suitable for printing.

11. The method of claim 2, wherein the second sub-computer system is only able to download all available information from the first sub-computer system if the first sub-computer system polls the second sub-computer system.

12. The method of claim 3, wherein the computer system is only able to transmit the formatted information to the appliance if the appliance polls the computer system.

13. The method of claim 1, wherein the computer system transmits a message to the mobile device after applying the designated information to the appliance.

14. A computer system which allows a user of a mobile device to apply information to an appliance designated by the mobile device, wherein the appliance is connected to the computer system, the computer system comprising:
a first interface for receiving both information requests and instructions from the mobile device via a first communication network, wherein the instructions designate the information to be processed and the appliance to which designated information is to be applied;
a second interface for sending the designated information to the appliance via a second communication network; and
a server computer system connected to the first interface and the second interface, for processing and answering the information requests, for processing the instructions, and further for sending the designated information to the appliance for processing.

15. The computer system of claim 14, wherein the information is stored in a first sub-computer system, wherein the first sub-computer system is connected to the computer system, wherein the information requests designate the first sub-computer system, and wherein the computer system further comprises a third interface connected to the server computer system for receiving the information sent from the first sub-computer system via a third communication network.

16. The computer system of claim 15, wherein the computer system further comprises a fourth interface connected to the server computer system for sending the information received from the first sub-computer system to a second sub-computer system via a fourth communication network.

17. The computer system of claim 14, wherein the first communication network and the second communication network share a part of one common communication network.

18. The computer system of claim 16, wherein at least two of the group comprising the first communication network, the second communication network, the third communication network, and the fourth communication network, share a part of one common communication network.

19. The computer system of claim 14, wherein the server computer system converts the designated information to a format suitable for the appliance.

20. The computer system of claim 14, wherein the appliance is a printer, and the server computer system converts the designated information to a print job in a format suitable for printing.
